(19) United States
(12) Patent Application Publication
(10) Pub. No.: US 2019/0082720 A1
(43) Pub. Date: Mar. 21, 2019

(54) Digestible Pet Chew

(71) Applicants: Jeffrey Lang, Meadville, PA (US); Andrew Teconchuk, Warren, PA (US); Rhonda Sisson, Warren, PA (US); Lee Randall, Meadville, PA (US); Larry Provencher, Edinboro, PA (US); Thomas Asquith, Cincinnati, OH (US); Brandon Senne, Topeka, KS (US)

(72) Inventors: Jeffrey Lang, Meadville, PA (US); Andrew Teconchuk, Warren, PA (US); Rhonda Sisson, Warren, PA (US); Lee Randall, Meadville, PA (US); Larry Provencher, Edinboro, PA (US); Thomas Asquith, Cincinnati, OH (US); Brandon Senne, Topeka, KS (US)

(21) Appl. No.: 16/192,087

(22) Filed: Nov. 15, 2018

Related U.S. Application Data
(63) Continuation of application No. 12/638,985, filed on Dec. 16, 2009.

(51) Int. Cl. A23K 50/45; A23K 20/22; A23K 40/25; A23K 40/20; A23K 20/163

(52) U.S. Cl. CPC A23K 50/45; A23K 20/22; A23K 20/163; A23K 40/20; A23K 40/25

(57) ABSTRACT

A cold-set, injection-molded digestible pet chew includes an outer skin layer having a tough, chewy texture and an expanded center being surrounded by the outer skin layer. The outer skin layer and the expanded center being are formed by injecting a plasticized mixture into a chilled mold and cooling in the mold for about 10-60 seconds followed by releasing the mold to allow the center to expand to form a digestible pet chew. The plasticized mixture includes protein, starch, 0.1-2.5% encapsulated leavening agent, acid, and 5-15% of a humectant. The encapsulated leavening agent reacts with the acid to form the expanded center within the outer skin layer. Further, the pet chew has a water activity of 0.60 or below such that the expanded center remains expanded.

### BRIEF DESCRIPTION OF THE DRAWINGS

FIG. 1a is a perspective view of a pet chew according to one embodiment;

FIG. 1b is the cross section of the pet chew of FIG. 1a;

FIG. 2a is a top view of a pet chew according to another embodiment;

FIG. 2b is a cross-sectional view of the pet chew of FIG. 2a;

FIG. 3a is a perspective view of a pet chew according to an additional embodiment;

FIG. 3b is a cross-sectional view of the pet chew of FIG. 3a;

FIG. 4a is a top view of a pet chew according to another embodiment;

FIG. 4b is a cross-sectional view of the pet chew of FIG. 4a;

FIG. 5a is a perspective view of a pet chew of another embodiment;

FIG. 5b is the cross-sectional view of the pet chew of FIG. 5a;

FIG. 6 is a flow chart illustration a method of forming a pet chew.

### DETAILED DESCRIPTION OF THE EMBODIMENTS

The embodiments described herein are directed to a composition for a digestible pet chew and methods for making the digestible pet chew. It is nevertheless understood that no limitations to the embodiments are thereby intended.

In general, a digestible pet chew 10 has a polymeric composition and an expanded appearance similar to that of bakery products. Pet chew 10 is readily chewable so that an animal's teeth can penetrate into the chew. It is sufficiently tough that it does not cause problems like choking. The pet chew is easily digested by the animal. It can be of various shapes and sizes and it can be produced by using several methods of preparation.

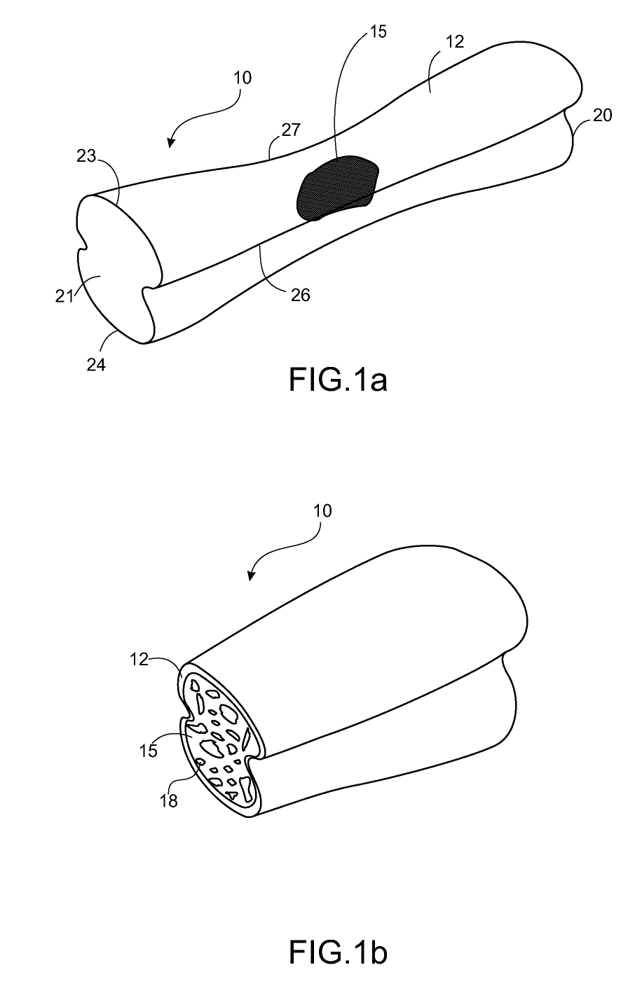

In one embodiment, as illustrated in FIGS. 1a and 1b, pet chew 10 takes the shape of a bone and it has an appearance similar to a bakery product. FIG. 1a illustrates the cross-sectional view of the product 10. In the embodiment shown in FIG. 1a-1b, pet chew 10 has an outer skin layer 12 and an expanded center 15 being surrounded by outer skin layer 12. The outer skin layer 12 provides pet chew with a tough, chewy consistency such that a dog or other pet may chew the product for an extended period of time. The expanded center 15 provides depth to the product. Air pockets 18 may form throughout expanded center 15. In the embodiment shown, pet chew 10 is formed from a plasticized mixture that is injected into a mold at a temperature of 70 degrees F. or cooler. The cool mold causes pet chew to form the outer skin layer 12. The plasticized mixture includes an encapsulated leavening agent and an acid. The outer skin layer prevents rapid release of gases which thus expand within the skin to form a matrix-like expanded center 15. The plasticized mixture will be described in more detail below.

Pet chew 10 includes a first and second ends 20 and 21, which correspond to the Z-axis of a mold (not shown), used to form pet chew 10. Side edges 26 and 27, which extend from first edge 20 to second edge 21, correspond to the X-axis of the mold. Thus, the Z-axis of the mold determines a pre-expansion length of pet chew 10 and the X-axis is the pre-expansion width of pet chew 10. In addition, pet chew 10 includes a top edge 23 and a bottom edge 24, which are defined by the Y-axis of the mold. The Y-axis is the pre-expansion thickness of pet chew 10. The dimensions of the mold cavity of the mold used to form pet chew 10 may have the following dimensions: Y=1″, X=1.5″ and Z=5.5.″ The expanded center 15 of pet chew 10 may be preserved by curing to water activities of 0.60 or lower. Alternatively the expanded center of pet chew 10 may be collapsed by equilibrating the chew at a water activity greater than 0.60. The amount of shrinkage depends on the water activity prior to equilibration. Thus, the greater the water activity the more shrinkage occurs. While not being bound by theory, we propose that water activities less than 0.60 maintain the expanded center of pet chew 10 below the glassy/rubbery transition whereas water activities greater than 0.60 moves the expanded center of pet chew 10 from the glassy state into the rubbery state.

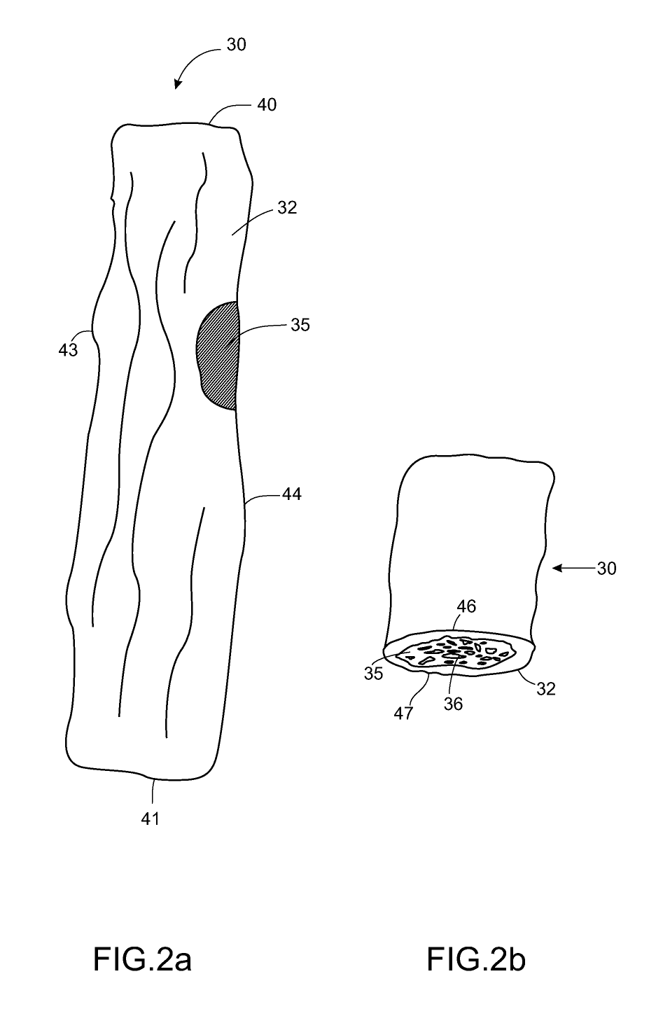

An additional embodiment of the digestible pet chew is indicated at 30 in FIGS. 2a and 2b. Pet chew 30 is a thin digestible pet chew having an outer skin layer 32 and an expanded center 35 surrounded by the outer skin layer 32. Expanded center 35 may have air pockets 36 formed therein. Pet chew 30 is formed by injecting a plasticized mixture, including an encapsulated leavening agent and an acid, into a thin mold. In one embodiment, the mold is heated to a temperature of at least 38 degrees C. in order to form pet chew 30, which has the appearance of a chicken strip. Expanded center 35 is much thinner than expanded center 15 of pet chew 10.

Pet chew 30 includes a first end 40 and a second end 41, which correspond to the Z-axis of the mold used to form pet chew 30. Side edges 43 and 44, which extend from first edge 40 to second edge 41, correspond to the X-axis of the mold. Thus, the Z-axis of the mold determines a pre-expansion length of pet chew 30 and the X-axis is the pre-expansion width of pet chew 30. In addition, pet chew 30 includes a top edge 46 and a bottom edge 47, which are defined by the Y-axis of the mold. The Y-axis is the pre-expansion thickness of pet chew 30. The dimensions of the mold cavity of the mold used to form pet chew 30 may have the following dimensions: Y=0.125″, X=1.5″ and Z=5.5″.

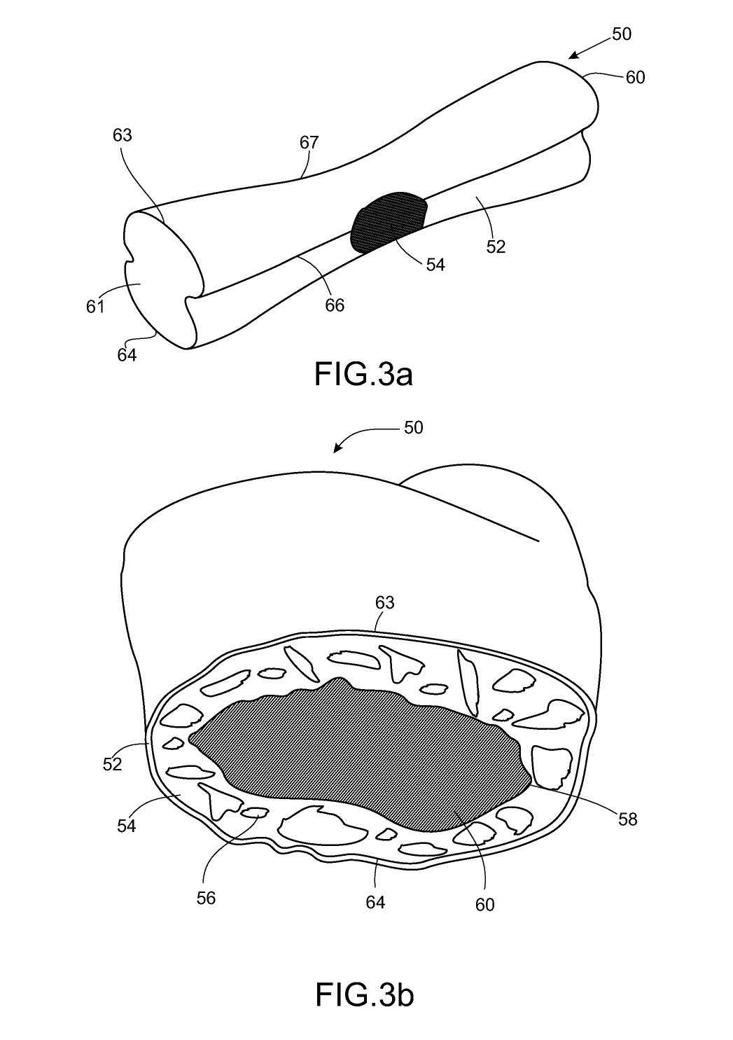

The embodiment shown in FIGS. 3a and 3b is digestible pet chew 50 having an outer skin 52 and an expanded center 54 with a hollow portion 58 therein. Expanded center 54 may have air pockets 56 formed therein. In addition, a filler material 60 may be injected into hollow portion 58. In one embodiment, pet chew 50 is formed by injecting into a mold chilled to a temperature of 21 degrees C. or cooler a plasticized mixture including an encapsulated leavening agent which is wholly or partially converted to carbon dioxide and optionally an acid. The pet chew formed by this method includes a hollow portion 60 formed within an expanded center 54.

Pet chew 50 includes a first end 60 and a second end 61, which correspond to the Z-axis of the mold used to form pet chew 50. Side edges 66 and 67, which extend from first edge 60 to second edge 61, correspond to the X-axis of the mold. Thus, the Z-axis of the mold determines a pre-expansion length of pet chew 50 and the X-axis is the pre-expansion width of pet chew 50. In addition, pet chew 50 includes a top edge 63 and a bottom edge 64, which are defined by the Y-axis of the mold. The Y-axis is the pre-expansion thickness of pet chew 50. The dimensions of the mold cavity of the mold used to form pet chew 50 may have the following dimensions: Y=1″, X=1.5″ and Z=5.5″.

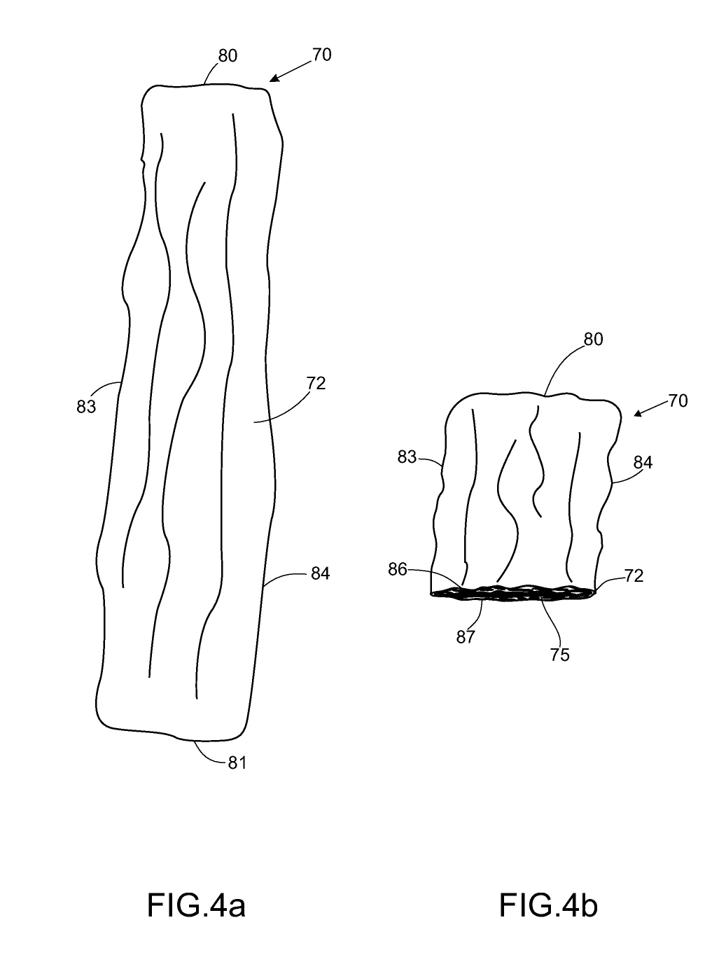

A fourth embodiment is illustrated in FIGS. 4a and 4b. Pet chew 70 includes an outer skin 72 and a collapsed center 75. Pet chew 70 may be formed by injecting into a mold chilled to a temperature of 21 degrees C. or cooler a plasticized mixture including 1.8% or greater of leavening agent which is wholly or partially converted to carbon dioxide and optionally an acid at about 1.2% or greater. The mixture is injected such that the time of rotational recovery approximates the cooling time of the material in the mold. Thus, the material is cooled in the mold for a minimum time sufficient to form a skin surrounding a center portion. The skin will be thin enough to allow gasses to escape through the skin but thick enough to hold the shape of the molded product. Following molding, pet chew 70 expands before collapsing to form a pet chew having a wrinkled outer skin 72 and a collapsed center 75. Pet chew 70 is cured within a range of water activity no greater than 0.80.

Pet chew 70 includes a first end 80 and a second end 81, which correspond to the Z-axis of the mold used to form pet chew 70. Side edges 83 and 84, which extend from first edge 80 to second edge 81, correspond to the X-axis of the mold. Thus, the Z-axis of the mold determines a pre-expansion length of pet chew 70 and the X-axis is the pre-expansion width of pet chew 70. In addition, pet chew 70 includes a top edge 86 and a bottom edge 87, which are defined by the Y-axis of the mold. The Y-axis is the pre-expansion thickness of pet chew 70. However, since pet chew 70 collapses following an initial expansion, the actual distance between top edge 86 and bottom edge 87 will be much less than the Y-axis of the mold. The dimensions of the mold cavity of the mold used to form pet chew 70 may have the following dimensions: Y=1″, X=1.5″ and Z=5.5″.

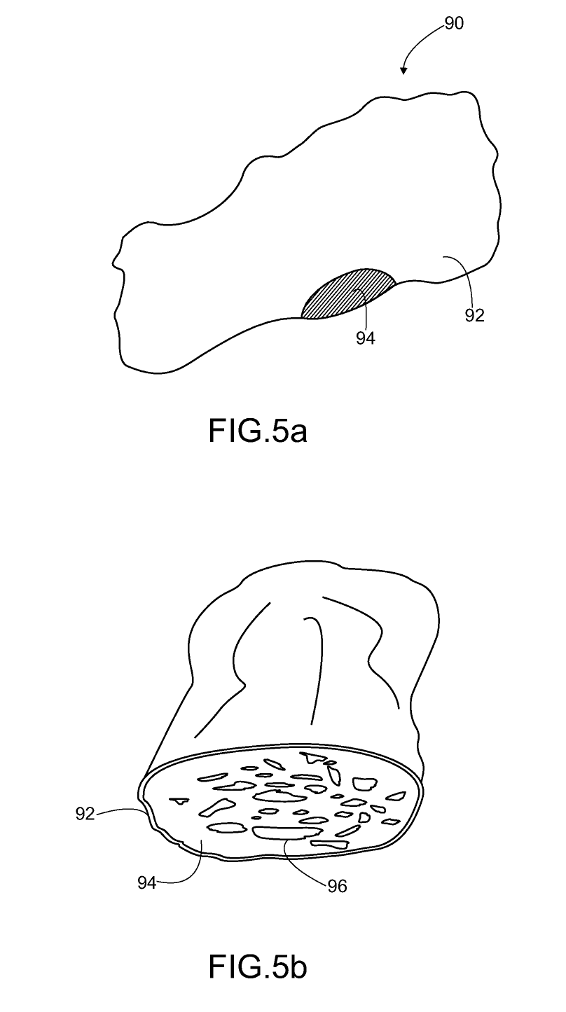

An additional embodiment is shown in FIG. 5b, which is an ejection product formed without a mold. As shown, a pet chew 90 includes an outer skin layer 94 and an expanded center 94, which is surrounded by outer skin 94. Air pockets 96 may form within expanded center 94, as shown in FIG. 5b. Pet chew 90 is formed by ejecting a plasticized material from an injection molding machine and allowing the plasticized material to freely expand. The pet chew is cured to a water activity of no greater than 0.80. Since pet chew 90 is not molded it does not have defined edges.

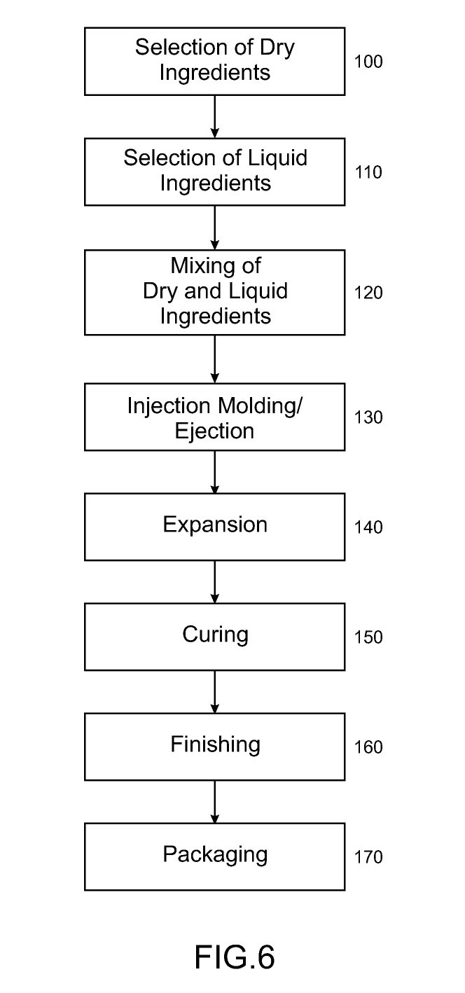

The method of producing the desired product depends on the desired shape and the resultant properties. One method of forming a pet chew 10 will be described with reference to the flow chart of FIG. 6. The method will be described with reference to pet chew 10; however, it should be recognized that the method may be used to form the pet chews of the other embodiments. As shown, the method initiates with selection of dry ingredients 100 which include, but are not limited to, plant or animal proteins, caseinate, wheat gluten or wheat flour, starch, gelatin, legume protein, and leavening agents. Additionally, some optional dry ingredients such as flavors, vitamin mix, wheat bran, dried fruit and whole grains can be added to the composition. The dry ingredients are mixed together in a blending apparatus/mixer such as paddle mixer, ribbon mixer or the like to produce a powder.

The next step in the preparation of pet chew 10 is selection of liquid ingredients 110. The liquid ingredients include, but are not limited to, plasticizers, water, edible oils, flavors, digests and the like. A blend is formed by mixing together the liquid ingredients and is introduced to the powder thereby resulting in the formation of a mixture. In addition, potassium sorbate can be added to the liquid ingredients. The blend of the liquid ingredients can be added to the powder by using variety of mixing techniques. The mixing of dry and liquid ingredients is represented by box 120 in FIG. 6. In one embodiment, the liquid ingredients are sprayed on the powder using a sprayer. The moisture content of the mixture is about 16-32% (w/w).

The mixture, formed after mixing the dry and the liquid ingredients, is plasticized (as described below) and subjected to a material shaping process 130. The choice of the shaping technique depends on the desired shape and appearance of the product. Two widely used techniques are injection molding and ejection. Both are done with pressures and temperatures typical of injection molding. For the ejection technique the plasticized dough is ejected to form foam. For the injection molding technique, the plasticized dough is injected into a mold to obtain a product having a three-dimensional shape. However, various other shaping techniques can also be used.

Prior to the injection molding or ejection process, the mixture is loaded in totes and is transferred to the production floor and then it is fed from the totes directly into the barrel of the injection molding machine. In the barrel, the mixture is plasticized by applying heat and pressure. The temperature in the barrel is in the range of 65° C.-135° C. (150° F.-275° F.). Typically temperatures are similar between zones of the barrel. The barrel of the injection molding machine is provided with a screw which rotates and exerts a back pressure on the material inside the barrel. The rotation speed of the screw varies from 5 rpm to 250 rpm and the back pressure ranges between 0 psi to 300 psi. A suitable plasticizer or softener can be added to the composition in the barrel to provide sufficient ductility to the mixture. The plasticizer used is such that it is readily digestible by the animal and does not cause any ill effects to it.

After plasticization, the mixture is ejected either to expand freely or it is injected into a mold, as indicated at step 140. The mold is at a relatively lower temperature as compared to the barrel. The temperature of the mold is typically in the range of about 10° F.-200° F. (−12° C.-93° C.) and the hot sprue temperature (i.e. the temperature at which the material enters into the mold) ranges from about 50° F. to 350° F. (10° C.-177° C.). The injection pressure is in the range of 500 psi to 19,900 psi, the injection velocity ranges from 0.2 in./sec to 6.3 in./sec and the hold pressure varies between 0 psi to 17,100 psi. The mold is provided with cavities of the desired shape. The plasticized mixture fills the mold and the expansion is confined to the contours of the mold. The material is then taken out of the mold as soon as it forms an outer skin while the center (core) is still expansive. After being taken out, the molded material, specifically the center, continues to expand (step 140, FIG. 3) in a controlled manner, on account of the constituents and their concentrations, thereby resulting in a product with desired surface structure, integrity, and uniformity. The expansion can be controlled by the composition of proteins and starches, amount of leavening agent, composition of the leavening agent, amount and composition of acid(s), shape of the cavities in the mold, the time allotted for the material to form a skin and by controlling the moisture/water activity of molded pieces. Contraction to a final shape can also be desirable. Contraction can be limited by keeping the curing water activities less than 0.60. Shelf life can be enhanced by mold inhibitors such as potassium sorbate or zinc propionate added to the composition in the range of about 0.10-0.80% (w/w).

In the ejection embodiment, the material is freely shaped upon ejection from the barrel. The expansion happens when the mixture is pushed through the nozzle to the open air. The mixture may be ejected into a lower pressure atmosphere for more expansion, or ejected into higher pressure atmosphere for less expansion. The products formed from expansion have less of a skin or exterior layer. The product formed by ejection is illustrated in FIGS. 5a-5b.

In the molded embodiments the material is injected into mold cavities. After the molded material has expanded, it is cured (step 150, FIG. 6) for about 2-4 days to form the final product with desired shape and properties. After being cured the material is subjected to some finishing processes 160 such as coating, cutting, and packaging 170 as illustrated in the FIG. 6.

In one embodiment, sodium bicarbonate is used as a leavening agent and is added in the range 0.1-2.5% (w/w). It is added to the composition at a stage when all the ingredients have been mixed and are ready to be sent to an injection molding machine or an extruder or any other material forming apparatus.

In another embodiment, encapsulated sodium bicarbonate is used as a leavening agent. It is added to the powder in an encapsulated form at the mixing stage. The encapsulation basically consists of fat which breaks down when heat is introduced, thereby preventing the sodium bicarbonate from reacting with the environment before the composition is heated. Encapsulation of sodium bicarbonate allows more control over the release of carbon dioxide. Faster or slower release of carbon dioxide can be optimized for different product shapes and foam structures.

Citric acid may also be added to the mixture. The citric acid, along with the leavening agents, reacts with the composition to give the product an expanded structure. The amount of citric acid added to the composition should be sufficient for conversion of the leavening agent(s) as well as to maintain product pH at or below 6.5. The amount of citric acid is generally 0.3 percentage points less than the amount of sodium bicarbonate. The acid enhances the reaction of sodium bicarbonate, thereby leading to a greater expansion of the composition. The reaction between the citric acid and leavening agent releases carbon dioxide which gets trapped within a conditioned cell type matrix of the formulation. The trapped gas expands the external surface volumetrically while creating a complex integrated internal cell structure similar to bakery type products. Maintaining the pH at or below 6.5 promotes the efficacy of potassium sorbate to prevent the mold growth after curing and packaging of the product.

In another embodiment, the casein used is sodium caseinate. Sodium caseinate is a protein rich substance and is used in the range 10-30% (w/w) in the composition. Other caseinates such as potassium caseinate, calcium caseinate can also be used. However, calcium caseinate was observed to deliver a puffed product with a rough texture.

The protein used may be wheat gluten or wheat flour. Wheat gluten is an elastic protein substance, and includes, but is not limited to, gliadin, glutenin, globulin and albumin. It is used in the range of 10-30% (w/w) in the composition. It contains about 12% (w/w) starch. Wheat Protein Isolate (WPI) can partially substitute for wheat gluten. If WPI nearly or wholly substitutes for wheat gluten then more starch may also be added. Further, glycerin is added in the range 5-15% (w/w). However, propylene glycol, sorbitol and other humectants can substitute for glycerin. Dough conditioners may also be added to the composition. Most commonly used dough conditioners are phosphates. Phosphates together with the moisture content of the composition maintain the expanded structure of the product and control voids.

The following examples are given solely for the purpose of illustration and are not to be construed as limitations of the embodiments as many variations thereof are possible without departing from the spirit and scope. All percentages used herein are by weight of the composition unless otherwise indicated.

### Formulation Examples

Each of the examples (1-6) given below was performed under same or substantially the same process conditions. The constituents were varies to demonstrate the changes in the product based on the changes in constituents.

TABLE 1
Examples using different types of caseinates.

| | Example 1 | Example 2 | Example 3 |
|---|---|---|---|
| Ingredient | (%) | (%) | (%) |
| Wheat Gluten | 25 | 25 | 25 |
| Sodium Caseinate | 21 | 0 | 0 |
| Potassium Caseinate | 0 | 21 | 0 |
| Calcium Caseinate | 0 | 0 | 21 |
| Tapioca Starch | 9 | 9 | 9 |
| Water | 12 | 12 | 12 |
| Glycerin | 11 | 11 | 11 |
| Pea Protein | 3 | 3 | 3 |
| Gelatin | 3 | 3 | 3 |
| Leavening Mix | 2.5 | 2.5 | 2.5 |
| Corn Oil | 2.5 | 2.5 | 2.5 |
| Inclusions & Flavors | 11 | 11 | 11 |
| Total Amount | 100 | 100 | 100 |

The above examples were conducted to determine the effect of various caseinates on the final product. It was observed that in example 1 (using sodium caseinate) and example 2 (using potassium caseinate) no substantial difference was found in terms of the product characteristics. However, in example 3 (using calcium caseinate) the product formed had a rough and thicker skin as compared to the skins of the products formed in the examples 1 and 2.

If cured to about 0.60 or less water activity, then products remain inflated. If they are partially cured (i.e. water activity about 0.65 to 0.80), and then moisture re-equilibrates, the products will “collapse”.

TABLE 2
Example of formula with no casein or gelatin

| Ingredient | Example |
|---|---|
| Corn Flour | 40.0 |
| Soy Flour | 20.0 |
| Water | 18.0 |
| Glycerin | 5.0 |
| Maltodextrin | 5.0 |
| Corn Oil | 1.0 |
| Leavening Mix | 2.5 |
| Inclusions & Flavors | 8.5 |
| Total Amount | 100 |

In the above example the product was made without any casein or gelatin. No significant changes were observed from removing the casein or gelatin. Thus, these are considered optional constituents and are not seen to affect the final product.

TABLE 3
Example of formula with modified starch and no gelatin.

| | Example |
|---|---|
| Ingredient | (%) |
| Wheat Gluten | 25 |
| Sodium Caseinate | 21 |
| Tapioca Starch | 9 |
| Rice Starch | 0 |
| Modified Starch | 3 |
| Water | 12 |
| Glycerin | 11 |
| Pea Protein | 3 |
| Gelatin | 0 |
| Leavening Mix | 2.5 |
| Corn Oil | 2.5 |
| Inclusions & Flavors | 11 |
| Total Amount | 100 |

In the above example, modified starch (i.e. Mira-gel) was added to the formulation as a substitute for gelatin. Yet, no substantial change was observed in the product characteristics.

TABLE 4
Examples of formulations with different
amounts and types of starches

| | Example 1 | Example 2 | Example 3 |
|---|---|---|---|
| Ingredient | (%) | (%) | (%) |
| Wheat Gluten | 25 | 19 | 25 |
| Sodium Caseinate | 21 | 21 | 21 |
| Tapioca Starch | 9 | 15 | 0 |
| Rice Starch | 0 | 0 | 9 |
| Water | 12 | 12 | 12 |
| Glycerin | 11 | 11 | 11 |
| Pea Protein | 3 | 3 | 3 |
| Gelatin | 3 | 3 | 3 |
| Leavening Mix | 2.5 | 2.5 | 2.5 |
| Corn Oil | 2.5 | 2.5 | 2.5 |
| Inclusions & Flavors | 11 | 11 | 11 |
| Total Amount | 100 | 100 | 100 |

The above examples were conducted with varying amounts and types of starches. The formulation typically contains about 11% (w/w) starch. The various sources of starch include, but are not limited to, wheat gluten, wheat flour, rice starch, and tapioca starch. Wheat gluten and pea protein contain about 12.5% (w/w) starch. Tapioca starch can partially replace wheat gluten. At least 15% (w/w) tapioca starch resulted in a suitable product. Other starches (e.g. rice) can substitute for tapioca starch without having a significant effect on product characteristics.

It was observed that product characteristics did not vary noticeably among the three formulations with different amounts and types of starches. All the three formulations yielded suitable products. In example 2, the amount of starch was increased and the amount of gluten was reduced. However, no change in the product characteristics was observed. In example 3, rice starch was substituted for tapioca starch without any change in the product's characteristics. Various other types and amounts of starches may also be added to the formulation.

TABLE 5
Example of formulation with soy protein as a substitute.

| | Example 1 |
|---|---|
| Ingredient | (%) |
| Wheat Gluten | 25 |
| Sodium Caseinate | 21 |
| Tapioca Starch | 9 |
| Water | 12 |
| Glycerin | 11 |
| Soy Protein | 3 |
| Gelatin | 3 |
| Leavening Mix | 2.5 |
| Corn Oil | 2.5 |
| Inclusions, Preservatives & Flavors | 11 |
| Total Amount | 100 |

In the above example soy protein was substituted for pea protein. No substantial difference in the product characteristics was observed. Proteins derived from chick peas, kidney beans, or other legumes can also be used.

TABLE 6
Examples of formulations with different leavening agents.

| | Ex. 1 | Ex. 2 | Ex. 3 | Ex. 4 | Ex. 5 | Ex. 6 |
|---|---|---|---|---|---|---|
| Ingredient | (%) | (%) | (%) | (%) | (%) | (%) |
| Wheat Gluten | 25 | 25 | 25 | 25 | 25 | 25 |
| Sodium | 21 | 21 | 21 | 21 | 21 | 21 |
| Caseinate | | | | | | |
| Tapioca Starch | 9 | 9 | 9 | 9 | 9 | 9 |
| Water | 12 | 12 | 12 | 12 | 12 | 12 |
| Glycerin | 11 | 11 | 11 | 11 | 11 | 11 |
| Pea Protein | 3 | 3 | 3 | 3 | 3 | 3 |
| Gelatin | 3 | 3 | 3 | 3 | 3 | 3 |
| Sodium | 0.9 | 1.0 | 0.9 | 0.9 | 0.9 | 1.8 |
| Bicarbonate | | | | | | |
| Sodium Acid | 1.0 | 1.0 | 1.0 | 1.0 | 0 | 1.0 |
| Pyrophosphate | | | | | | |
| Sodium | 0 | 0 | 0 | 0 | 1.0 | 0 |
| Tripolyphosphate | | | | | | |
| Citric Acid | 0.6 | 0.6 | 0 | 0 | 0.6 | 1.2 |
| Malic Acid | 0 | 0 | 0.4 | 0 | 0 | 0 |
| Fumaric Acid | 0 | 0 | 0 | 0.4 | 0 | 0 |
| Corn Oil | 2.5 | 2.5 | 2.5 | 2.5 | 2.5 | 2.5 |
| Inclusions, | 11 | 10.9 | 11.2 | 11.2 | 11 | 9.5 |
| Preservatives | | | | | | |
| & Flavors | | | | | | |
| Total Amount | 100 | 100 | 100 | 100 | 100 | 100 |

The above examples were conducted with different leavening agents. Encapsulated baking soda can be used (example 2). It was observed that a variety of acids can be used, with all resulting products yielding suitable characteristics. As seen in the example 3, malic acid can replace citric acid without noticeable change in product characteristics. Either organic or inorganic acids can be substituted (example 4 and example 5). Also, the amount of the leavening mix can be changed to adjust final volume of products.

However, it was observed that if the amount of leavening mix (i.e. acid and sodium bicarbonate) is doubled (Example 6), the product expands but then it collapses. The resulting product has a smooth yet wrinkled surface and an elastic skin. It is similar to a raw hide in appearance. The shape of the product is illustrated in FIG. 4.

### Process Examples

In each of the following examples, the process parameters and mold cavity dimensions were varied to observe their effect on product characteristics. Note that work was done with test molds. Process conditions may differ when applied to production molds.

PROCESS TABLE 1
Mold cavity dimensions: Y = 1″, X = 1.5″, Z = 5.5″

| Process parameters | Example 1 | Example 2 | Example 3 |
|---|---|---|---|
| Injection pressure, psi | 2000 | 4500 | 4500 |
| Hold pressure, psi | 10 | 10 | 10 |
| Injection velocity, in./sec | 1.57 | 1.57 | 1.57 |
| Rotation speed (screw), rpms | 62.5 | 62.5 | 62.5 |
| Back pressure, psi | 10 | 10 | 10 |
| Barrel temperature, ° F. (° C.) | 185 (85) | 181 (83) | 181 (83) |
| Mold temperature, ° F. (° C.) | 32 (0) | 32 (0) | 32 (0) |
| Cooling/curing time, sec. | 20 | 60 | 20 |
| Hot sprue temperature, ° F. | 240 (116) | 240 (116) | 240 (116) |
| (° C.) | | | |

In the above listed three examples the cavity of the mold used had the following dimensions: Y=1″, X=1.5″ and Z=5.5.″ In one embodiment, the mold used is of the shape of a bone, which produces a product as illustrated in FIGS. 1a-1b. In examples 1-3, the injection pressures and cooling/curing time are varied, other parameters remaining essentially the same.

In example 1, the product obtained was observed to have expanded in all three dimensions (axes). In example 2, the injection pressure was more than doubled and the cooling time was tripled as compared to example 1 and it was observed that the product showed appreciable expansion along the Z-axis after being taken out of the mold. However, no considerable expansion was noticed in the X and Y directions.

In example 3, the injection pressure was the same as that in example 2 but the cooling time was reduced to 20 seconds. The product was observed to have expanded along the X and Y axes but the expansion along Z-axis was minimal. Though the products obtained in all the three examples mentioned above differed in their physical attributes, they all are within the scope of embodiments described herein.

PROCESS TABLE 2
Mold Cavity Dimensions Y = .125″, X = 1.5″ and Z = 5.5″

| Process parameters | Example 1 | Example 2 |
|---|---|---|
| Injection pressure, psi | 2000 | 2000 |
| Hold pressure, psi | 0 | 0 |
| Injection velocity, in./sec | 1.57 | 1.57 |
| Rotation speed (screw), rpms | 138 | 138 |
| Back pressure, psi | 0 | 0 |
| Barrel temperature, ° F. (° C.) | 181 (83) | 181 (83) |
| Mold temperature, ° F. (° C.) | 100 (38) | 32 (0) |

In the above mention examples, the mold used had the following dimensions: Y=0.125″, X=1.5″ and Z=5.5″ (i.e. a thinner mold was used). In the example 1 and 2 only the mold temperature was varied while the other parameters were kept the same in both the examples. In example 1, the mold was held to 100° F. (38° C.) and the product was observed to expand in all three dimensions. The product 40 is similar to a chicken strip as illustrated in FIGS. 6a and 6b. In FIG. 6a, the top view of the product 40 is shown whereas FIG. 6b illustrates the side view of the product 40.

In example 2, the mold was kept at a temperature of 32° F. (0° C.). The product was observed to have some undesirable features such as an unpliable skin and minimal expansion. The only expansion the product underwent was along the Z-axis.

PROCESS TABLE 3
Y = 1″, X = 1.5″ and Z = 5.5″; increased barrel temperature
and injection velocity, with reduced cooling/curing time

| Process parameters | Example |
|---|---|
| Injection pressure, psi | 2000 |
| Hold pressure, psi | 0 |
| Injection velocity, in./sec | 2.5 |
| Rotation speed (screw), rpms | 138 |
| Back pressure, psi | 10 |
| Barrel temperature, ° F. (° C.) | 195 (91) |
| Mold temperature, ° F. (° C.) | 32 (0) |
| Cooling/curing time, sec. | 10 |
| Hot sprue temperature, ° F. (° C.) | 240 (116) |

In the above mention examples, the mold used had the following cavity dimensions: Y=1″, X=1.5″ and Z=5.5″ In this example, relative to example 1 of process table 1, the hold pressure was reduced from 10 to 0, injection velocity was increased from 1.57 in./sec to 2.5 in./sec, rotation speed was more than doubled from 62.5 rpm to 138 rpm, the barrel temperature was increased from 185° F. to 195° F. (85° C. to 91° C.), and the cooling/curing time was reduced from 20 seconds to 10 seconds. The resulting product 20 was observed to be hollow as illustrated in FIGS. 7a and 7b. FIG. 7a illustrates the top view of the hollow product 20 whereas FIG. 7b illustrates the cross sectional view of the product 20.

It was observed that by increasing the barrel temperature and injection velocity, while reducing the cooling/curing time, the reaction starts prior to injection of the formulation into the mold cavity, trapping the gases in the product 20, thereby creating a void 50 within the product 20. A filler material 60 can be injected into the void 50 of the product 20 as illustrated in FIG. 7c.

Although described with reference to selected embodiments, it should be readily understood that various changes and/or modifications can be made to the methods and products described herein without departing from the spirit thereof. For instance, any number of different non-reactive additives may be added to the formulations to benefit the palatability or desirability of the product. Therefore, the embodiments are only intended to be limited by the scope of the following claims.

We claim:

1. A cold-set, injection-molded digestible pet chew comprising: an outer skin layer having a tough, chewy texture; and
an expanded center being surrounded by said outer skin layer, said outer skin layer and said expanded center being formed by injecting a plasticized mixture into a chilled mold and cooling in the mold for about 10-60 seconds followed by releasing the mold to allow the center to expand to form a digestible pet chew;
said plasticized mixture comprising protein, starch, 0.1-2.5% encapsulated leavening agent, acid, and 5-15% of a humectant, wherein the encapsulated leavening agent reacts with the acid to form the expanded center within the outer skin layer and wherein the pet chew has a water activity of 0.60 or below such that the expanded center remains expanded.

2. The pet chew of claim 1 wherein the pet chew has a thickness of about 1.5 inches and is formed in a mold cavity having a thickness of about 1.5 inches.

3. The pet chew of claim 1 wherein the plasticized mixture includes a modified starch.

4. The pet chew of claim 1 wherein the leavening agent is encapsulated sodium bicarbonate.

5. The pet chew of claim 1 wherein the plasticized mixture contains 2.5% leavening agent.

6. The pet chew of claim 1 wherein the plasticized mixture further includes:
caseinate, legume protein, gelatin, and edible oil.

7. The pet chew of claim 6 wherein the caseinate is sodium caseinate present in the amount of 10 to 30%.

8. The pet chew of claim 1 wherein the protein is wheat gluten and is present in the amount of about 25%.

9. The pet chew of claim 1 wherein the mold is chilled to a temperature of 70 degrees F. or cooler.

10. The pet chew of claim 1 wherein the starch is selected from the group consisting of tapioca starch, rice starch, potato starch and corn starch and is present in the amount of 12-15%.

11. The pet chew of claim 6 wherein the gelatin is present in the amount of 1 to 10%.

12. The pet chew of claim 1 wherein the protein is legume protein present in the amount of 1 to 10%.

13. The pet chew of claim 6 further including potassium sorbate present in the amount of 0.1 to 0.8%.

14. The pet chew of claim 1 wherein the acid is selected from the group consisting of citric acid, malic acid, and fumaric acid.

15. The pet chew of claim 1 wherein the acid is present in an amount sufficient to maintain the pH of the product at 6.5 or less.

16. A injection molded pet chew comprising:
a cold-set, injection-molded body formed from a mixture including 10-30% wheat gluten, 10-30% caseinate, about 3% of a protein selected from the group consisting of: soy protein, pea protein, or other legume protein, and 9-15% starch ingredient, about 0.3-2.5% leavening mix, and 5-15% of a humectant, the injection-molded body having an expanded, matrix-like center portion and an outer skin layer having a tough, chewy texture that is integral with and surrounding the expanded, matrix-like center portion, said injection-molded pet chew having a pH of 6.5 or less and a water activity of 0.6 or less.

17. The injection molded pet chew of claim 16 wherein the leavening mix includes an acid selected from the group consisting of citric acid, malic acid, and fumaric acid.

18. The injection molded pet chew of claim 16 wherein the leavening mix includes sodium bicarbonate in an amount of greater than 0.3% and up to an amount of 2.5% (W/W) and citric acid in an amount of 0.3% less than the amount of sodium bicarbonate.

19. The digestible pet chew according to claim 1, wherein the plasticized mixture includes water, 10-30% wheat gluten, 10-30% caseinate, 1-10% of a protein selected from the group consisting of: soy protein, pea protein, or other legume protein, 9-15% of a starch ingredient selected from the group consisting of tapioca starch, rice starch, potato starch and corn starch, oil, 0.3-2.5% leavening mix, and 5-15% of a humectant.
